(19) United States
(12) Patent Application Publication
(10) Pub. No.: US 2018/0144194 A1
(43) Pub. Date: May 24, 2018

(54) METHOD AND APPARATUS FOR CLASSIFYING VIDEOS BASED ON AUDIO SIGNALS

(71) Applicant: Jinsoo Park, Seongnam-si (KR)

(72) Inventor: Jinsoo Park, Seongnam-si (KR)

(21) Appl. No.: 15/362,171

(22) Filed: Nov. 28, 2016

(30) Foreign Application Priority Data
Nov. 22, 2016 (KR) 10-2016-0156014

(51) Int. Cl. G06K 9/00; H04N 21/439; H04N 21/44; H04N 21/454

(52) U.S. Cl. CPC G06K 9/00744; H04N 21/4542; H04N 21/44008; H04N 21/4394

(57) ABSTRACT

An apparatus for classifying videos according to an embodiment of the present invention comprises: an audio extractor for extracting an audio signal upon receiving video information; an audio signal classifier for outputting primary classification information from the audio signal; and a video classifier for performing secondary classification on video data of the video information using the primary classification information.

### TECHNICAL FIELD

The present invention relates to a method and an apparatus for classifying videos. More particularly, the present invention relates to a method and an apparatus for classifying videos based on audio signals, which provide faster and more accurate video classification.

### BACKGROUND OF ART

Next generation telecommunication technology 5G is proposed beyond the current LTE technology, and the development of the telecommunication technology lowers the limit of the transmission capacity for the users. Accordingly, the next generation telecommunication technology brings explosive improvement in both quantity and quality of video content. In addition, with the miniaturization and high resolution of cameras, average users can create high quality videos using mobile phones.

It led to rapid increase of a portion of video data on networks and number of videos. Recently, videos of 400 minutes are uploaded in every minute on YouTube, and this figure is rapidly increasing. Under this circumstance, it is almost impossible to classify videos manually. Accordingly, there is a need for a new intelligent alternative.

To solve this problem, automatic classification system through video analysis, direct classification method by user using tag, category, etc. are in the spotlight as new intelligent alternatives.

Automatic classification system is an automated process system, in which technologies such as Deep Neural Network (DNN) used for AI (Artificial Intelligence) recognition system is adopted, and videos are analyzed using video processing technique and automatically classified in a predetermined manner.

However, such automatic classification needs to analyze each unit scene of the video by segmentation to classify and then analyze every scene individually, which is very time-consuming.

Moreover, since current automatic classification only provides a half the accuracy of single classification, there is a problem that the classification should be corrected manually.

On the other hand, there is an alternative of direct classification method that a producer who produced the video or a viewer who watched the video put a tag. But, there is an obvious limitation.

For example, there are problems that videos with low view counts are difficult to classify and tag classification is subjective. Moreover, there is a possibility of malicious wrong classification using bot.

Meanwhile, Convolutional Neural Network (CNN) which is attracting attention due to its high accuracy in the field of video and image analysis involves the same problems. As CNN figures out a feature of an image through several Convolution operations and samplings to classify, a large amount of operation is needed to accurately classify even only one image and it does not show high accuracy.

In addition, for most music-related videos, people usually recognize the content as music, but the actual video is PV, music video, or random illustration, etc., which may not be consistent with the subject of music or song. Accordingly, it is very difficult to distinguish videos through video analysis.

Due to the above described problems, some harmful videos such as obscene content, tenor video are still not filtered properly and the fact is that filtering is complemented by users.

### DETAILED DESCRIPTION OF THE INVENTION

### Technical Problem

The present invention has been designed is to solve the above-mentioned problems, and the object thereof is to provide a method and an apparatus for classifying videos based on audio signal in which intelligent multilayer classification through machine learning is applicable without additional aid and accuracy and classification speed are greatly improved by performing primarily classification of the videos through composite features of audio signal and processing video classification into detailed category based on them.

### Technical Solution

In order to achieve the above objects, an apparatus for classifying videos according to an embodiment of the present invention comprises: an audio extractor for extracting an audio signal upon receiving video information; an audio signal classifier for outputting primary classification information from the audio signal; and a video classifier for performing secondary classification on video data of the video information using the primary classification information.

Also, in order to achieve the above objects, a method for classifying videos according to an embodiment of the present invention comprises the steps of: extracting an audio signal upon receiving video information; outputting primary classification information from the audio signal; and performing secondary classification on video data of the video information using the primary classification information.

Meanwhile, in order to achieve the above objects, a method for classifying video according to an embodiment of the present invention may be implemented as a non-transitory computer-readable medium having stored thereon computer-executable program and the program.

### Advantageous Effects

According to embodiments of the present invention, videos can be primarily classified using composite features of audio signals. Moreover, since video classification into detailed category can be applied based on them, intelligent multilayer classification through machine learning is applicable without additional aid, and it is possible to provide a method and an apparatus for classifying videos based on audio signal with greatly improved accuracy and classification speed.

### BRIEF DESCRIPTION OF DRAWINGS

FIG. 1 is a block diagram showing an overall system according to an embodiment of the present invention.

FIGS. 2-3 are drawings illustrating a method for extracting audio according to an embodiment of the present invention.

FIGS. 4-7 are drawings illustrating an operation of the audio signal classifier 200 according to an embodiment of the present invention more specifically.

FIG. 8 shows audio features of videos used for setting broad category corresponding to the primary classification information.

FIGS. 9-10 are drawings illustrating a classification method of the video classifier 300 according to an embodiment of the present invention more specifically.

FIG. 11 shows an example of broad category defined in the audio signal classifier 200, and FIG. 12 shows an example of detailed category defined in the video classifier 300 on the basis of the broad category.

FIGS. 13-14 are drawings illustrating changes of scanning region for each of the video category according to an embodiment of the present invention.

### DETAILED DESCRIPTION OF THE EMBODIMENTS

The present invention may have various modifications and embodiments, and some specific embodiments will be exemplified in the drawings and described in detail in the detailed description.

However, it is not intended to limit the present invention to a specific embodiment, and it should be understood to include any modification, equivalent and replacement that are made within the idea and technical scope of the invention. While explaining the present invention, terms such as “first” and “second,” etc., may be used to describe various components, but such components are not to be understood as being limited to the above terms. The above terms are used only to distinguish one component from another. For example, a first component may be referred to as a second component without departing from the scope of the present invention, and likewise a second component may be referred to as a first component.

It is to be understood that when an element is referred to as being “coupled to” or “connected to” another element, such an element may be directly coupled to or connected to the other element or intervening elements may also be present. In contrast, when an element is referred to as being “directly coupled to” or “directly connected to” another element, no intervening elements are present.

The terms used in the present disclosure are merely used to describe certain embodiments, and are not intended to limit the present invention. Singular forms may include the plural forms as well, unless the context clearly indicates otherwise. In this specification, terms such as “including” or “having,” etc., are intended to indicate the existence of the features, numbers, steps, operations, components, parts, or combinations thereof, and are not intended to preclude the possibility that one or more other features, numbers, steps, operations, components, parts, or combinations thereof exist or are added. Unless otherwise defined, all terms used herein, including technical or scientific terms, have the same meanings as those generally understood by those with ordinary knowledge in the field of art to which the present invention belongs.

Such terms as those defined in a generally used dictionary would be interpreted to have the meanings equal to the contextual meanings in the relevant field of art, and they would not be interpreted to have ideal or excessively formal meanings unless clearly so defined in the present application. Further, the following embodiments are provided to assist those with ordinary knowledge in the field of art to which the present disclosure belongs in gaining a comprehensive understanding, and shapes and dimensions of the elements in the drawing may be exaggerated for clearer expressions.

For example, block diagrams of the present disclosure should be understood to indicate conceptual view of exemplary circuit implementing principles of the present invention. Functions of various devices shown in the drawings including a processor or a functional block indicated as a similar concept may be provided by a special purpose hardware and other hardware capable of executing software in association with proper software as well. When it is provided by processors, the function may be provided by a single special purpose processor, a single shared processor or a plurality of individual processors, and some of which can be shared. In addition, clear use of processor, control, or other terms present as similar concepts should not be construed to refer hardware capable of executing software exclusively, but it should be understood that digital signal processor (DSP) hardware, read-only memory (ROM), random-access memory (RAM) and non-volatile memory for storing software are implicitly included. Well-known other hardware can also be included.

In the claims of the present disclosure, elements expressed as means for performing functions described in the detailed description are intended to include all methods for performing functions, for example, a combination of circuit elements performing the above functions or all types of software including firmware/microcode, which are combined with proper circuits to execute the software to perform the functions. The present invention defined by such claims in which functions provided by the variously listed means are combined and they are combined with the manner in which the claims require, any means capable of providing the functions should be understood to be equivalent to those understood from the present disclosure

Now, a preferred embodiment of the present invention will be described in detail with reference to the accompanying drawings.

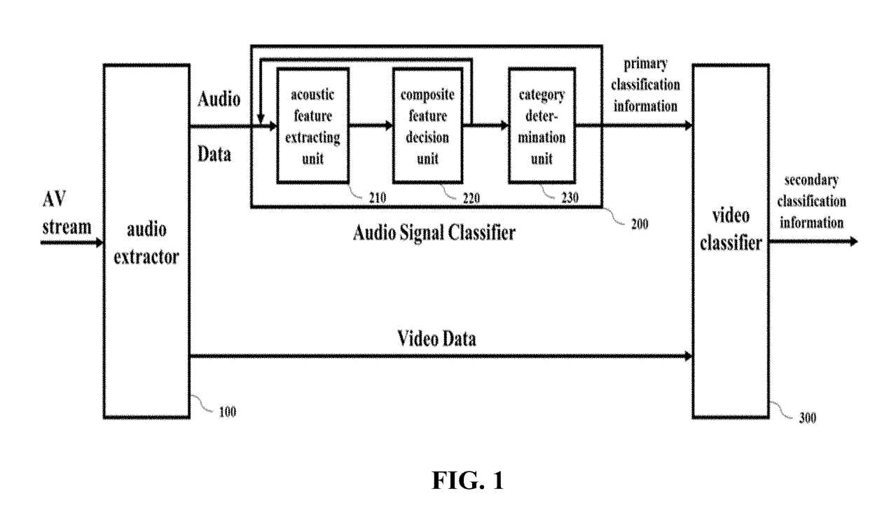

FIG. 1 is a block diagram showing an overall system according to an embodiment of the present invention.

Referring to FIG. 1, an overall system according to an embodiment of the present invention comprises an audio extractor 100, an audio signal classifier 200 and a video classifier 300.

The audio extractor 100 extracts audio data from inputted AV (Audio & Video) stream and sends them to the audio signal classifier 200.

For example, the audio extractor 100 may be located outside or inside of the classification system for classifying videos, and extract an audio signal from a video including AV stream. For example, the audio extractor 100 may include a de-multiplexer (DEMUX) for extracting audio signals from each of a plurality of files having various formats according to the purposes of use.

Accordingly, the audio extractor 100 can extract audio signals from a part or the entirety of a file depending on the format of the video file.

For example, the audio extractor 100 can extract audio signals from files of various formats including general video formats such as MP4, AVI, WMV, streaming service and other formats depending on purposes and needs of users and businesses.

Then, the audio signal classifier 200 receives data corresponding to the audio signal, extracts acoustic feature information, determines a category of the audio signal based on composite feature decision, and outputs corresponding primary classification information to the video classifier 300.

In particular, the audio signal classifier 200 according to an embodiment of the present invention precedes a primary level classification only with the extracted audio signals, which mitigates operational load of the video classifier 300 while providing fast and precise classification.

To this end, the audio signal classifier 200 may include an acoustic feature extracting unit 210, a composite feature decision unit 220 and a category determination unit 230.

The acoustic feature extracting unit 210 can determine the presence or absence of feature information and occurrence interval thereof by analyzing audio signal extracted by the audio extractor 100. The acoustic feature extracting unit 210 can identify the occurrence (or appearance) for time interval of predetermined acoustic feature data (for example, human voice, sound of a specific instrument, detonation, handclapping, cheering, and sound generated from other factors).

To this end, the acoustic feature extracting unit 210 may include various analyzing means for analyzing audio signals. The acoustic feature extracting unit 210 can analyze audio signals using frequency block separation method utilizing Fourier transform or pattern matching method identifying specific patterns matched with time-specific data of frequency, and it can determine the existence and occurrence interval of acoustic feature information using spectrograph, hidden Markov model, Gaussian mixture model, etc.

Also, the composite feature decision unit 220 can process acoustic feature information for each time interval obtained from the acoustic feature extracting unit 210 as primary feature data, and decide composite feature information on the basis of the primary feature data. The composite feature information can be decided on the basis of the existence of acoustic feature data determined primarily, relationship information therebetween, and other required information.

More specifically, the composite feature decision unit 220 can decide existence of the composite feature such as music, detonation, etc. using occurrence data of feature information for each time interval.

Also, if there is a composite feature, the composite feature decision unit 220 can identify whether there is additional basic acoustic feature other than the basic acoustic feature belonging to the corresponding feature. For example, the composite feature of “music” may constituted of a basic acoustic feature of the existence of the sound of instrument and the human vocal and tone and frequency related information. Accordingly, the composite feature decision unit 220 can reconfirm the primary acoustic features constituting the composite feature.

Thus, the composite feature decision unit 220 can decide if there is a voice of other person or a sound of other instrument besides human vocal and instrument included in the music feature information. This process is required to distinguish additional basic acoustic feature different from background music or original soundtrack in the video.

When the extraction of the composite feature and the recovery of the existing feature in the composite feature decision unit 220 are completed, the feature data for each time interval is transferred to the category determination unit 230.

Then, the category determination unit 230 determines the category within which the corresponding audio falls via the feature data for each time interval.

To this end, the category determination unit 230 determines classification category of the audio data on the basis of the composite feature information outputted from the composite feature decision unit 220 and the acoustic feature information, and outputs the primary classification information depending on the category to the video classifier 300.

The category determination unit 230 analyzes the distribution of individual feature on the basis of the present or absence data of the acoustic feature information for each time interval obtained for the audio data and the composite feature information and is capable of substantially classifying the audio data.

The category classified accordingly may be applicable to primary classification information. The primary classification information can correspond to broad category information to conclusively classify the video information of AV stream. Such broad category information can be changed depending on the purpose of a user, for example, it can be decided according to the video classification method of SNS.

Meanwhile, the video classifier 300 classify the video primarily on the basis of the primary classification information (or broad category) that is classified based on audio feature of the video and is capable of perform more precise secondary classification through video analysis of the primarily classified video.

Through the secondary classification, the video classifier 300 may determine a detailed category.

Accordingly, the video classifier 300 can process the secondary analysis for the primarily classified video using well-known video analysis methods. For example, hidden Markov model or deep neural network, etc. can be used. Through those video analyses, the video classifier 300 can index video feature information distinguishing detailed category within the primarily classified broad category depending on the audio signals.

The video classifier 300 may determine the detailed category as the secondary classification of the video if the video feature information is indexed.

For example, the video classifier 300 can process the detailed classification of the video on the basis of the broad category information classified by the audio signal classifier 200. At this time, the video classifier 300 can process the secondary classification in the manner that it indexes the distinguishing feature information as the detailed category belonging to a broad category.

However, in a case where the video itself has different audio feature and video feature such as a synthetic video, it is possible that no feature information is indexed. In this case, additional correction process may be required.

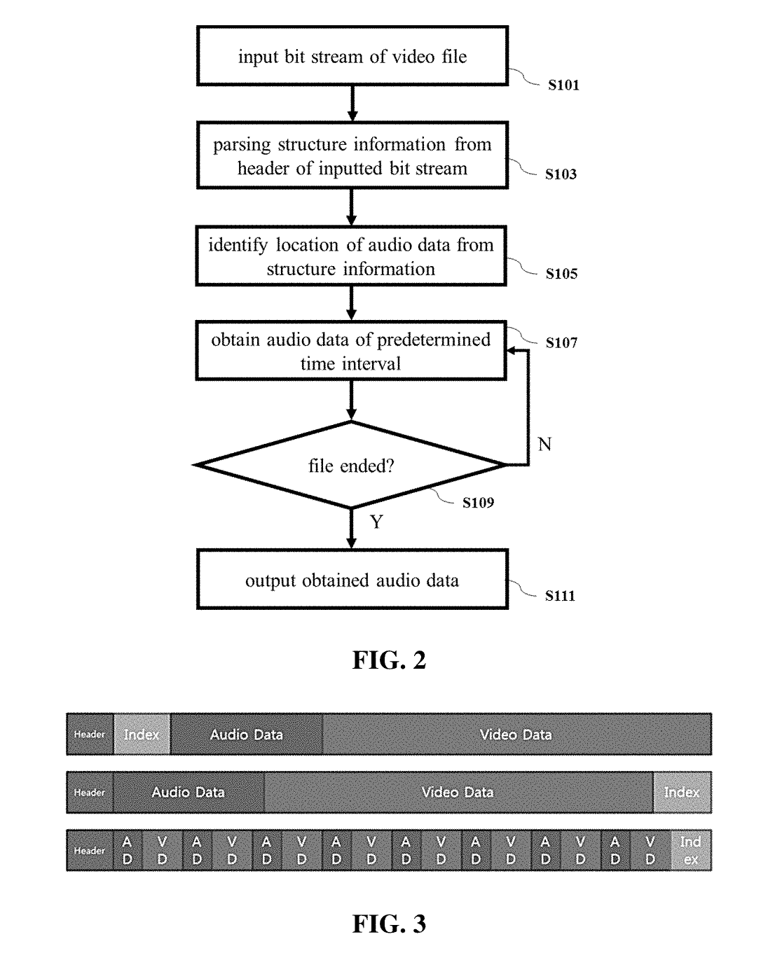

FIGS. 2-3 are drawings illustrating a method for extracting audio according to an embodiment of the present invention.

As shown in FIGS. 2-3, the audio extractor 100 can handle location identification of the audio section and audio signal acquisition in case of frequently used file format in general.

While files generally used have various formats including streaming, they can have three common file structures that can be represented by FIG. 3 on the whole. Accordingly, the audio extractor 100 can extract audio from three types of video files.

To this end, the audio extractor 100 can figure out the format and structure information of the file by reading out the header present inside the file. The audio extractor 100 then identifies metadata and audio data including voice or acoustic information through the header and the index, and moves to the location of the audio data to extract the audio data of a specific time interval. As the process goes through the whole video, the audio extractor 100 may generate audio data corresponding to the whole video or a specific section to transfer to the audio signal classifier 200.

Now, it will be described in sequence with reference to FIG. 2.

First, the audio extractor 100 receives bit stream of an AV file (S101), and parses structure information from the header of the inputted bit stream (S103).

Then, the audio extractor 100 identifies the location of the audio data from the structure information (S105), and obtains the audio data corresponding to the predetermined time interval (S107).

Subsequently, the audio extractor 100 determines if the file ended (S109), and outputs the obtained audio data to the acoustic feature extracting unit 210 of the audio signal classifier 200 if the file ended (S111).

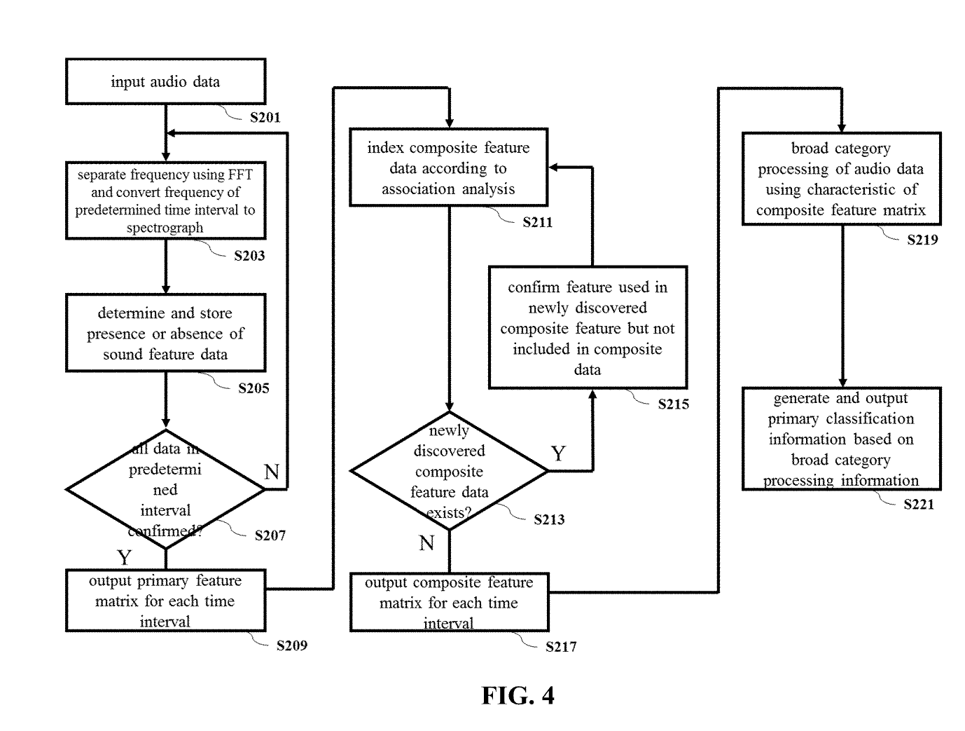

FIGS. 4-7 are drawings illustrating an operation of the audio signal classifier 200 according to an embodiment of the present invention more specifically.

FIG. 4 is a flowchart illustrating an operation of the audio signal classifier 200, and it is described in detail with reference to FIGS. 5-7.

Referring to FIG. 4, the audio signal classifier 200 first receives the extracted audio data from the audio extractor 100 (S201), separates by frequency through the acoustic feature extracting unit 210 using Fourier transform, and transforms the frequency for each time interval of the separated data by the acoustic feature extracting unit 210 to spectrograph (S203).

Then, the acoustic feature extracting unit 210 determines and stores the existence and the occurrence interval of the acoustic feature data according to the comparison between the spectrograph and the predetermined matching frequency (S205).

While it is illustrated in the embodiment that the acoustic feature extracting unit 210 performs Fourier transform for audio analysis, two embodiments can be exemplified largely.

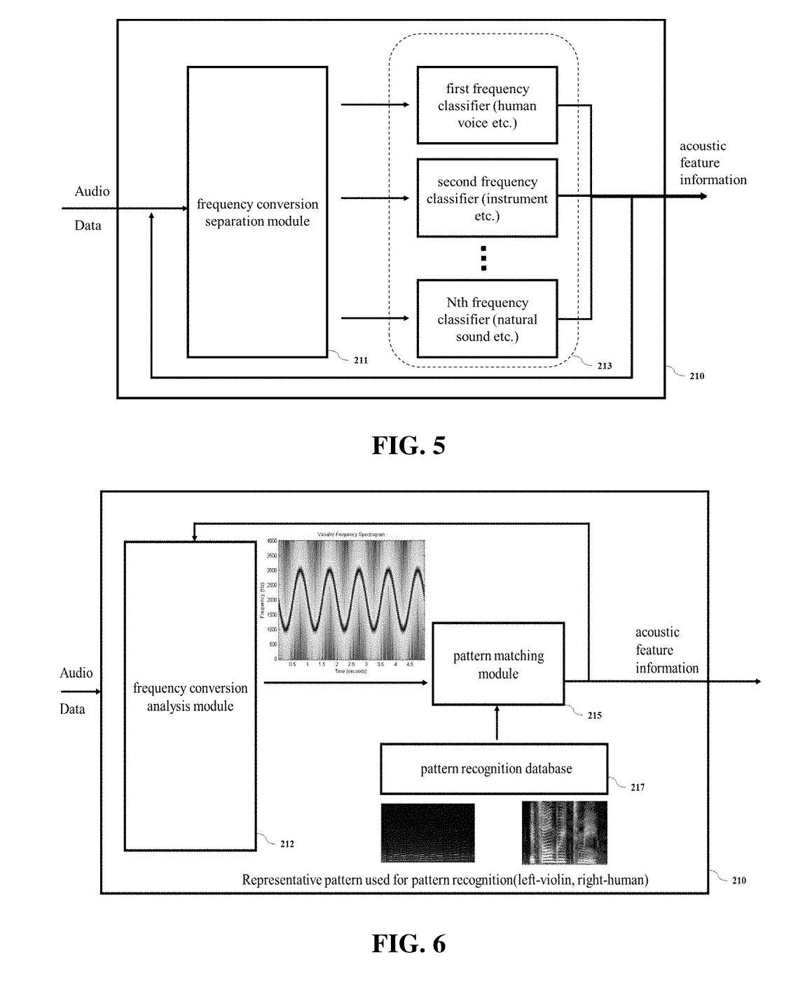

It will be described in more detail with reference to FIGS. 5 and 6.

FIG. 5 is a block diagram illustrating the constitution of the acoustic feature extracting unit 210 according to the frequency matching based on Fourier transform among audio analysis technique.

The acoustic feature extracting unit 210 that processes frequency matching may include a frequency conversion separation module 211 and a plurality of frequency classifiers 213.

The frequency conversion separation module 211 can divide the voice data of a specific time interval based on the analysis in the frequency region such as Fourier transform into each frequency section, and perform classifying process into the plurality of frequency classifiers 213 thereupon.

For example, the plurality of frequency classifiers 213 may include a first frequency classifier corresponding to human voices, a second frequency classifier corresponding to instrumental sounds such as violin, cello, piano, drum, guitar, bass, etc. and a Nth frequency classifier corresponding to sounds such as detonation, gunshot, sounds or sound effects such as cheering, handclapping, engine sounds such as vehicle exhaust sound, natural sound such as noise, and miscellaneous sound. Such matching frequency classification may be constituted variously depending on purposes and genres.

Meanwhile, FIG. 6 is a block diagram illustrating the constitution of the acoustic feature extracting unit 210 according to the pattern matching based on spectroscopy.

Referring to FIG. 6, the acoustic feature extracting unit 210 may include a frequency conversion analysis module 211, a pattern matching module 215 and a pattern recognition database 217.

The frequency conversion analysis module 211 analyzes the audio data based on frequency, and generates frequency spectrogram of voice signal for each time interval to provide to the pattern matching module 215.

Then, the pattern matching module 215 compares the spectrogram with the representative patterns previously stored in the pattern recognition database 217 and determines the existence of the feature information depending on the matching result to output.

As shown in FIGS. 5 and 6, the acoustic feature extracting unit 210 can use various voice classification methods identifying existence of a specific feature (tone color) corresponding to a specific time interval.

Also, acoustic feature information extracted accordingly can correspond to each time interval, and thus, the acoustic feature information may have a form of a feature matrix for each time interval.

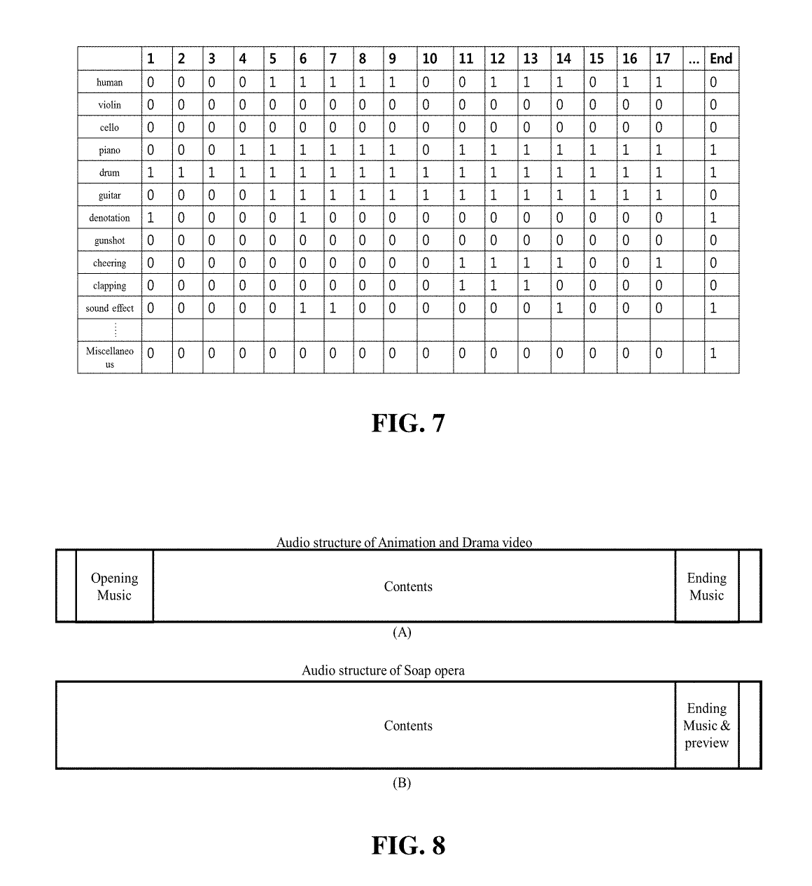

FIG. 7 is a diagram illustrating a form of a feature matrix for each time interval of the acoustic feature information.

The extraction of the audio feature by the acoustic feature extracting unit 210 can be operated for the whole section or a specific selected section depending on the purpose of the user.

In particular, each feature can be represented by its existence within a certain time interval (t˜t+Δt) in a specific section.

For example, the time-specific primary acoustic feature matrix can be expressed by the existence of the feature within a specific time interval as shown in FIG. 7.

Also, the acoustic feature extracting unit 210 may extract and store additional features of the audio such as tone, note (frequency), etc. required for determination of the composite feature by the composite feature decision unit 220 other than the presence or absence.

For example, the composite feature decision unit 220 may identify a ‘song with vocal’ as a composite feature. In this case, the composite feature is constituted of both human voice and instrumental sound. Accordingly, the acoustic feature extracting unit 210 may store the presence of the human voice and instrumental sound and features such as their frequency or tone as well. At this time, the presence or absence of each feature and the temporal information in which the corresponding feature exists can be matched and stored together in the acoustic feature information.

Referring back to FIG. 4 again, in a case where the feature information of the data in the predetermined time interval is confirmed (S207), the acoustic feature extracting unit 210 outputs the matrix information including primary acoustic feature information for each time interval to the composite feature decision unit 220 (S209).

Then, the composite feature decision unit 220 indexes the composite feature data from the matrix based on association analysis between feature matrixes (S211). If there is a newly discovered composite feature data (S213), it confirms the feature information that is used in the newly discovered composite feature data but not included in the composite data (S215).

To explain this more specifically, the case where the composite feature decision unit 220 decides ‘music with vocal’ may be illustrated as an example.

The composite feature, ‘music with vocal’, may include voice information of the singer and sound information of the associated instruments.

Accordingly, the composite feature decision unit 220 decides that the composite feature is present when there are human voice and instrumental sound simultaneously in the same time interval.

Thus, the composite feature decision unit 220 can compare the notes (frequencies) and tone colors of human voice and instrument used in case of a time interval matrix having two features simultaneously. And, the composite feature decision unit 220 can decide that ‘music with vocal’ is present when the differences of notes and tone colors are below threshold values.

Meanwhile, if the composite feature decision unit 220 discovered a pattern corresponding to a new composite feature, it may record that the new composite feature is existent instead of recording each feature element constituting the composite feature.

In a case where a new composite feature is discovered, the composite feature decision unit 220 needs to decide if there are features constituting the composite feature once again. This is because there might be a primary feature that is not included in the new composite feature present in the audio signal.

For example, even if it is ‘music with vocal’, there may be normal voice without singing in various videos such as Drama, Gaming, Crime, Animation etc. when background music (BGM) or OST is playing. Like this, since there can be other primary acoustic feature than primary acoustic features constituting the composite feature, the composite feature decision unit 220 may decide the existence of the primary acoustic feature once again for elements constituting a new composite feature.

Also, the composite feature decision unit 220 may confirm the existence of the composite feature having continuity based on its continuity. For example, in case of ‘music with vocal’, the entire song or a specific section thereof can be played at once due to the characteristics of the song. Like this, even if there are no human voice or instrumental sound for a short time, the composite feature decision unit 220 can decide that there is the composite feature of the ‘music with vocal’ when the same composite feature as the current time interval is present before or after the current time.

Referring back to FIG. 4 again, if no more additional composite feature is discovered, the composite feature decision unit 220 outputs the composite feature matrix for each time interval that is finally confirmed to the category determination unit 230 (S217).

Subsequently, the category determination unit 230 performs broad categorization of the audio data using features of the composite feature matrix (S219), generates primary classification information on the basis of broad category process information to output to the video classifier 300 (S221).

Here, referring to FIG. 8, the process of determining broad category as primary classification information used in an embodiment of the present invention is described. Here, the broad category is a genre of the video as an example.

FIG. 8 shows audio features of vides used for setting broad category corresponding to the primary classification information.

The broad category is basically to group videos having similar audio structure among videos belonging to each category.

FIG. 8 (A) shows audio features of an animation and a drama having very similar audio structure. Videos of those genres can have an opening music featuring characteristics of the series inserted in the beginning part of the video and an ending music wrapping up the respective episode. Also, during that time, other audio feature may not appear to be overlapped.

Accordingly, if there is music in the beginning and the ending parts of the video, that video is likely to be an animation or drama. Similarly, music appears on both ends parts of the news or current affairs show. However, since there usually is very short signature music in the beginning part of the news or current affairs show, and it explains major issues or gives an outline of the video simultaneously with the music, it is different.

FIG. 8 (B) shows audio features of a soap opera. In case of a soap opera, music may not be appeared in the beginning part different from the animation or drama. In addition, a trailer is inserted in the ending part, and the trailer may appear with the representative music of the soap opera (OST: Original/Official Sound Track).

As shown in FIGS. 8 (A) and (B), the category determination unit 230 can determine the category of the video using overall audio feature of the video. Also, the category determination unit 230 may determine the broad category through presence of a specific sound. For example, in cases where a detonation is occurred, the category determination unit 230 may determine that it is one of action, war, documentary, science & technology, or western movie.

Similarly, in case of talk shows, cheering and clapping sounds come out when a guest appears, and in case of sports, cheering sounds come out upon scoring. Accordingly, the category determination unit 230 can process broad category determination based on those characteristic features.

Also, other than this, the category determination unit 230 can determine the video as music if there are no other features other than instrumental sound and human voice (in case of music with vocal) or if there are other features only in the beginning or ending part.

Also, in case of official music video, since there may be other features in the beginning or ending part, the category determination unit 230 may not consider some parts of the beginning and ending parts to determine music video.

As in the above examples, there are unique audio patterns present in each video. Accordingly, through audio analysis considering such patterns, the category determination unit 230 can determine broad category of the video.

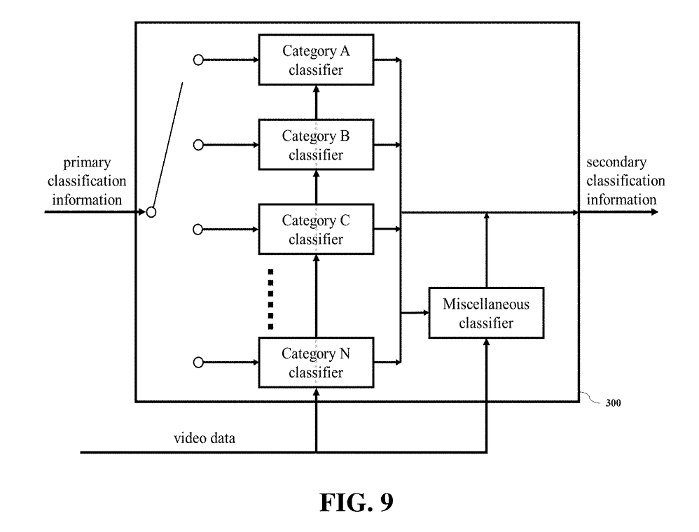

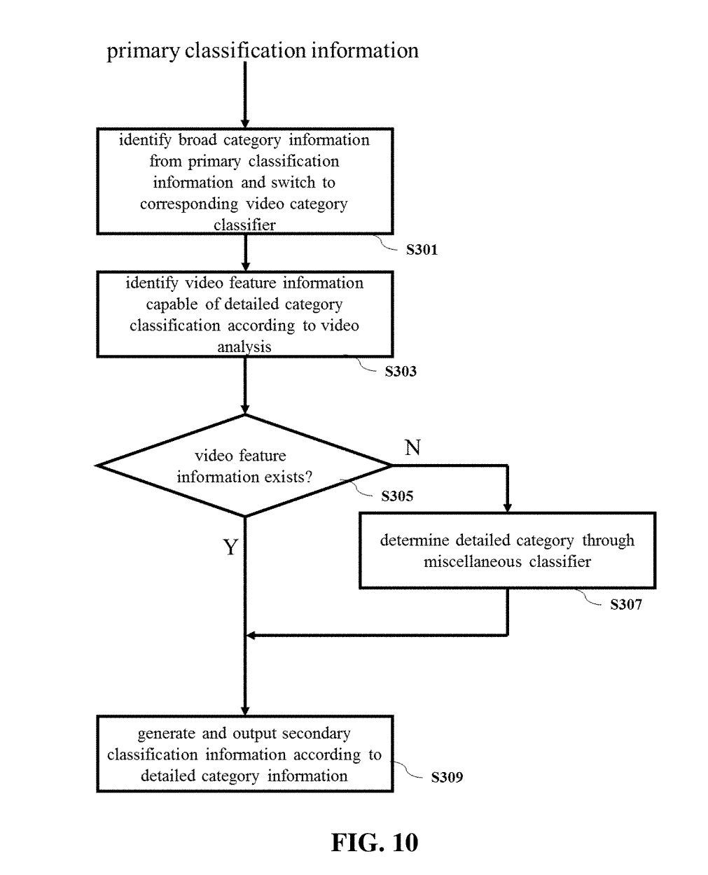

Meanwhile, FIGS. 9-10 are drawings illustrating a classification method of the video classifier 300 according to an embodiment of the present invention more specifically.

Referring to FIGS. 9-10, the video classifier 300 may determine more precise detailed category through the broad category result information obtained from the primary classification information and video analysis based on them, and send the detailed category as secondary classification information.

To this end, as shown in FIG. 9, the video classifier 300 may include a plurality of video category classifiers for determining detailed category based on the primary classification information and the video data outputted from the audio extractor 100.

Accordingly, the video classifier 300 can perform detailed video classification faster and more effectively based on the broad category result information through audio classification and video data. This is because video features distinguishing each detailed category belonging to a broad category are different depending on the broad category.

Thus, the video classifier 300 may include a switch for selecting a video category classifier using inputted primary classification information. Accordingly, each video category classifier can index different video features. Also, in a case where the video category classifier indexed video features, the video classifier 300 may determine a detailed category having such video features as the secondary classification information of the video.

If audio features of the video and features of the actual video are very different from each other and there is no feature information corresponding to a detailed category, the video classifier 300 sends it to the miscellaneous classifier to perform additional classification and complemental process using conventional method that specifies main objects directly.

FIG. 10 is a flowchart showing classification method of the above described video classifier 300.

First, the video classifier 300 identifies broad category information from primary classification information upon receiving the primary classification information from the audio signal classifier 200 and performs switching operation to a video category classifier corresponding to the broad category information (S301).

Then, the video classifier 300 identifies video feature information enabling detailed classification of category according to the video analysis using the video category classifier (S303).

After that, if there is video feature information, the video classifier 300 generates and outputs secondary classification information depending on the detailed category information corresponding to the video feature information (S309).

On the other hand, if there is no video feature information, the video classifier 300 may determine the detailed category through the miscellaneous classifier (S307).

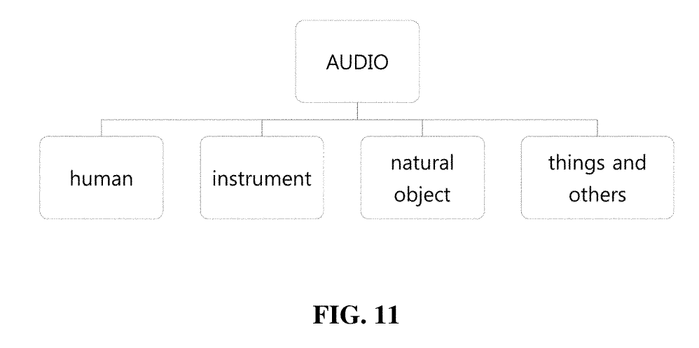

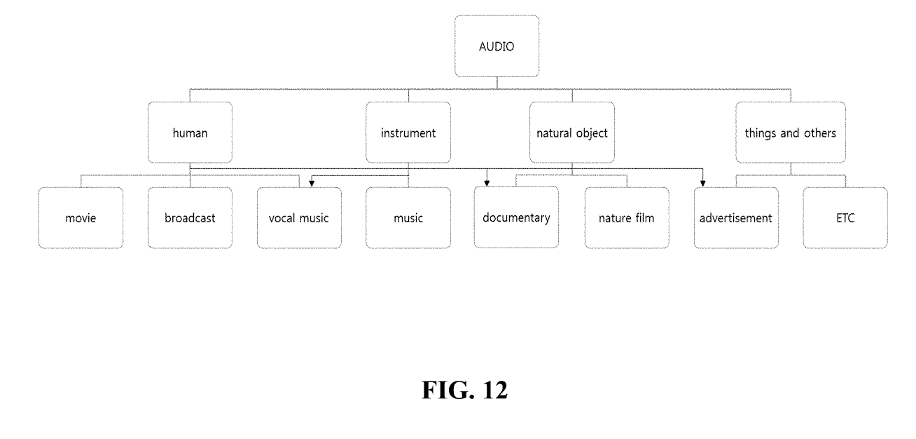

To explain an exact operation of the video classifier of FIG. 10, it is described how the video classifier is operated in association with the audio signal classifier through an embodiment using a broad category and a detailed category of FIGS. 11 and 12.

FIG. 11 shows an example of broad category defined in the audio signal classifier 200, and FIG. 12 shows an example of detailed category defined in the video classifier 300 on the basis of the broad category.

FIG. 11 is a diagram illustrating broad categories usable in the audio signal classifier 200. As shown in FIG. 11, the audio signal classifier 200 can handle classification using features of audio signal itself of a specific video. Accordingly, different from a conventional content analysis technique using video features, videos can be classified based on existence of specific sounds or other audio features.

Such classification process of the audio signal classifier 200 is not only for precise classification but also for providing advanced information usable for video classification.

Accordingly, as shown in FIG. 12, some detailed categories as secondary classifications may belong to several broad categories at the same time.

Thus, the broad category of FIG. 11 can be used to estimate detailed category of the video on the basis of the existence of each sound. In addition, detailed categories of FIG. 12 can be determined complexly, based on the broad category determined through the existence of the sounds.

Accordingly, FIG. 12 shows the relationship between the detailed category and the broad category that can be determined by the video classifier 300 as a hierarchical structure.

Meanwhile, according to an embodiment of the present invention, the composite feature decision unit 220 can perform analysis using additional complex features as well as the classification method using the existence of specific audio features.

For example, the composite feature decision unit 220 can confirm the language that the video is manufactured using word recognition function. Also, the composite feature decision unit 220 can generate broad category information by the method of distinguishing specific main characters.

In this case, the composite feature decision unit 220 can extract required feature information, and then, the video classifier 300 can index the detailed category by the way of searching video feature mainly appearing in respective language or searching specific characters.

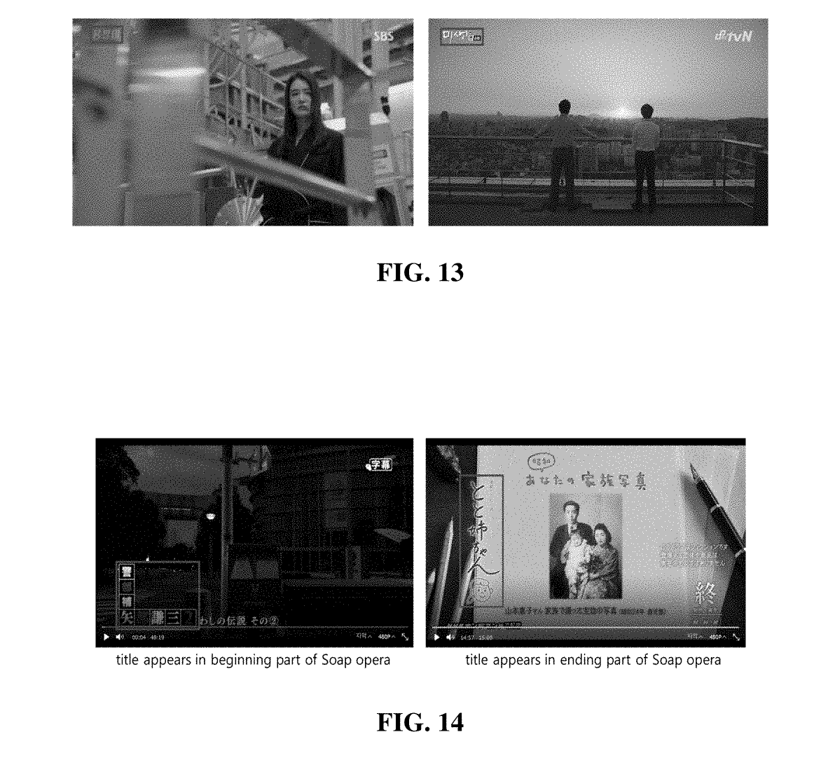

FIGS. 13-14 are drawings illustrating a change of scanning region for each of the video category according to an embodiment of the present invention.

As described above, video features specifying the detailed category may exist for each broad category.

Accordingly, video feature information that the video category classifier of the video classifier 300 tries to index can be different among broad categories determined by audio classification of the audio signal classifier 200

Thus, broad category can serve as a switch for the video category classifier of the video classifier 300. Therefore, in accordance with the broad category based on audio analysis of the video, main scanning region can be applied differently during video analysis of the video classifier 300.

FIG. 13 shows characteristics of animation and drama videos. For both animation and drama, a logo indicating a title of the respective video can be displayed upper left/right side. Even if the logo is removed or not displayed, the title of the respective video can be displayed in the video proceeding with an opening music.

Accordingly, to distinguish the animation and drama, the video classifier 300 identifies if there is an opening music in the respective video, and scans the opening video or logo region present in the upper part of the general video.

Through this classification method, in case of a logo, the video classifier 300 can analyze a predetermined region of a few frames randomly sampled from the video. In a case where the opening video is analyzed, the video can be classified from analysis of only a few minutes (e.g. 1 to 2 minutes) corresponding to the opening from videos of at least 30 minutes long. It is advantageous that classification can be performed very quickly comparing to the conventional classification method.

In addition, FIG. 14 shows the case of soap opera genre.

The video classifier 300 can classify the soap opera in a manner similar to an animation or a drama in case where ending music exists in its ending part.

In case of soap opera, the video classifier 300 can classify the detailed category through the title of the drama that can be found in the ending music of the ending part of the video or logo of the upper part. Video features of such soap opera are shown identically in FIG. 14.

Meanwhile, if there is a detonation, it can be classified into Action, War, Documentary, Western genre as broad categories. The detailed categories can be complex, however, the video classifier 300 can utilize predetermined scanning region and feature information.

For example, in case of Western movie with Midwest America as its main setting, the video classifier 300 compares the background of the respective video to a desert with bushes or feature information corresponding to similar landscapes.

In case of Documentary, the video classifier 300 can check the feature information providing additional information such as caption. In case of Documentary, its main purpose is to provide information, which is different from movie. Accordingly, complete scene change in editing may not be present very often, and the video classifier 300 can consider this point. Meanwhile, in case of Action movie with detonation, the video classifier 300 may trace car explosion or big explosion appearing in the video on a specific time point for classification.

As described above, the video classifier 300 can perform precise detailed classification by analyzing video for other genres as well.

Meanwhile, the method and apparatus for classifying video based on audio signal can be modified and used for various fields and purposes due to the faster processing and improved accuracy.

For example, for filtering harmful content according to the video classification method of the present invention, the broad category information classified by the audio signal classifier 200 and the detailed category information classified by the video classifier 300 can be used. Also, the broad category information and the detailed category information can be utilized to index specific content. In addition, it can be applied to a new content generation that creates content grouped by the detailed category according to the video classification method.

The above-described method according to the present invention can be written as a program to be executed by a computer and stored on a computer-readable recording medium, and the examples of the computer-readable recording medium are ROM, RAM, CD-ROM, magnetic tapes, floppy disks, optical data storages, etc.

The computer-readable recording medium may be distributed over network coupled computer systems so that the computer-readable code is stored and executed in a distributed fashion. In particular, the software and data may be stored by one or more non-transitory computer readable recording mediums. The media may also include, alone or in combination with the software program instructions, data files, data structures, and the like. In addition, functional programs, codes, and code segments for accomplishing the method can be construed by programmers skilled in the art to which the present invention belongs.

While preferred embodiments of the present invention are shown and described above, the present invention is not limited to the preferred embodiments, it will be apparent to one of ordinary skill in the art that various modifications can be made to the invention without departing from the gist of the present invention claimed by the claims, and these should not be understood individually from the technical idea or view of the present invention.

1. An apparatus for classifying videos comprising:
an audio extractor for extracting an audio signal upon receiving video information;
an audio signal classifier for outputting primary classification information from the audio signal; and
a video classifier for performing secondary classification on video data of the video information using the primary classification information.

2. The apparatus for classifying videos of claim 1, wherein the audio signal classifier includes an acoustic feature extracting unit for extracting acoustic feature information from data input corresponding to the audio signal.

3. The apparatus for classifying videos of claim 2, wherein the acoustic feature information includes acoustic feature matrix information indicating whether the acoustic feature information is generated for a predetermined time interval.

4. The apparatus for classifying videos of claim 3, wherein the acoustic feature extracting unit includes a frequency conversion separation module for obtaining the acoustic feature information based on frequency conversion separation.

5. The apparatus for classifying videos of claim 3, wherein the acoustic feature extracting unit includes a pattern matching module for obtaining the acoustic feature information based on pattern matching according to frequency analysis.

6. The apparatus for classifying videos of claim 2, further comprising a composite feature decision unit for indexing and outputting composite feature data according to an association analysis between the acoustic feature information and predetermined composite feature information.

7. The apparatus for classifying videos of claim 6, further comprising a category determination unit for outputting broad category information of the audio signal as the primary classification information based on the acoustic feature information and the composite feature data.

8. The apparatus for classifying videos of claim 1, wherein the video classifier includes at least one video category classifier for determining the secondary classification upon indexing video feature information of a predetermined condition determined based on the primary classification information.

9. A method for classifying videos comprising the steps of:
extracting an audio signal upon receiving video information;
outputting primary classification information from the audio signal; and
performing secondary classification on video data of the video information using the primary classification information.

10. The method for classifying videos of claim 9, wherein the step of outputting the primary classification information includes a step of extracting acoustic feature information from data input corresponding to the audio signal.

11. The method for classifying videos of claim 10, wherein the acoustic feature information includes acoustic feature matrix information indicating whether the acoustic feature information is generated for a predetermined time interval.

12. The method for classifying videos of claim 11, further comprising a step of indexing and outputting composite feature data according to an association analysis between the acoustic feature information and predetermined composite feature information.

13. The method for classifying videos of claim 12, further comprising a step of outputting broad category information of the audio signal as the primary classification information based on the acoustic feature information and the composite feature data.

14. The method for classifying videos of claim 9, further comprising a step of determining the secondary classification upon indexing video feature information of a predetermined condition determined based on the primary classification information.
